(19) United States
(12) Patent Application Publication
(10) Pub. No.: US 2024/0413344 A1
(43) Pub. Date: Dec. 12, 2024

(54) SECONDARY BATTERY

(71) Applicant: MURATA MANUFACTURING CO., LTD., Kyoto (JP)

(72) Inventors: Hironobu KUBOTA, Kyoto (JP); Takeshi HAYASHI, Kyoto (JP); Kazuki FUKUI, Kyoto (JP); Takashi KASASHIMA, Kyoto (JP); Takuya NAKASHIMA, Kyoto (JP)

(21) Appl. No.: 18/812,072

(22) Filed: Aug. 22, 2024

Related U.S. Application Data
(63) Continuation of application No. PCT/JP2023/000087, filed on Jan. 5, 2023.

(30) Foreign Application Priority Data
Mar. 15, 2022 (JP) 2022-040726

(51) Int. Cl. H01M 4/62; C07F 7/18; C07F 7/21; H01M 4/02; H01M 4/36; H01M 10/0525

(52) U.S. Cl. CPC H01M 4/625; C07F 7/1804; C07F 7/21; H01M 4/366; H01M 10/0525; H01M 2004/028

(57) ABSTRACT

A secondary battery is provided and including an electrode containing an electrode active material and a conductive material, in which at least a part of the conductive material is covered with a covering material, and a covering amount of the covering material is 0.0008 mmol/m² or more and 0.06 mmol/m² or less.

### CROSS REFERENCE TO RELATED APPLICATIONS

The present application is a continuation of PCT patent application no. PCT/JP2023/000087, filed Jan. 5, 2023, which claims priority to Japanese patent application no. 2022-040726, filed on Mar. 15, 2022, the entire contents of which are incorporated herein by reference.

### BACKGROUND

The present disclosure relates to a secondary battery.

A secondary battery generally has a structure in which a positive electrode, a negative electrode, a separator disposed between the positive electrode and the negative electrode, and an electrolyte are enclosed in an exterior body. The electrodes such as the positive electrode and the negative electrode, in particular, the positive electrode contains positive electrode active material particles as an electrode active material.

For example, in a lithium ion secondary battery, a part of a positive electrode active material and a conductive material contained in a positive electrode is covered with lithium ion conductive glass. It is shown that the covering can suppress oxidative decomposition of the electrolyte and can suppress deterioration of battery performance such as gas generation and battery capacity.

### SUMMARY

The present disclosure relates to a secondary battery.

According to the research by the inventors of the present application, it has been found, for example, that in the conventional technique, cycle characteristics related to discharge capacity and electrode resistance are not sufficient, and there is room for further improvement. Specifically, the electrode usually includes other electrode constituent materials other than the electrode active material such as a conductive material together with the electrode active material. Such other electrode constituent materials reacted with an electrolyte or the like to generate gas, and/or deposit by-products on the surface thereof. Therefore, due to charge-discharge cycle (that is, repetition of charge and discharge), the discharge capacity decreased and/or the electrode resistance increased, resulting in deterioration of cycle characteristics.

The present disclosure, in an embodiment, relates to providing a secondary battery capable of more sufficiently preventing deterioration of cycle characteristics related to discharge capacity and electrode resistance.

The present disclosure, in an embodiment, relates to a secondary battery including:
an electrode containing an electrode active material and a conductive material,
in which at least a part of the conductive material is covered with a covering material, and
a covering amount of the covering material is 0.0008 mmol/m² or more and 0.06 mmol/m² or less.

The secondary battery of the present disclosure, in an embodiment, has sufficiently improved chemical stability, and as a result, can more sufficiently prevent the deterioration of cycle characteristics related to discharge capacity and electrode resistance.

### DETAILED DESCRIPTION

The secondary battery of the present disclosure includes an electrode containing an electrode active material and a conductive material (hereinafter, sometimes referred to as “the electrode of the present disclosure”). In the present specification, the term “secondary battery” refers to a battery that can be repeatedly charged and discharged. Thus, the secondary battery according to an embodiment of the present disclosure is not excessively limited by its name, and for example, an electrochemical device such as a power storage device may also be included in the secondary battery.

The electrode of the present disclosure has a conductive material covering structure in which at least a part of the conductive material is covered with a covering material. Therefore, chemical stability of the secondary battery is sufficiently improved, a reaction of the conductive material with an electrolyte or the like is more sufficiently prevented, and generation of gas and generation of by-products are more sufficiently prevented. As a result, the deterioration of the cycle characteristics related to discharge capacity and electrode resistance is more sufficiently prevented.

In the present specification, the cycle characteristics related to discharge capacity are characteristics that the discharge capacity is more sufficiently maintained also by charge-discharge cycle (that is, repetition of charge and discharge).

The cycle characteristics related to electrode resistance are characteristics in which an increase in the electrode resistance is more sufficiently prevented also by charge-discharge cycle (that is, repetition of charge and discharge).

Hereinafter, the cycle characteristics related to discharge capacity and the cycle characteristics related to electrode resistance are sometimes referred to as “the cycle characteristics”.

In the present disclosure, in an embodiment, the electrode having a conductive material covering structure may correspond to a positive electrode, a negative electrode, or both a positive electrode and a negative electrode. Specifically, only the positive electrode may have a conductive material covering structure, only the negative electrode may have a conductive material covering structure, or both the positive electrode and the negative electrode may have a conductive material covering structure. In the present disclosure, in an embodiment, the electrode having a conductive material covering structure preferably corresponds to at least the positive electrode, for example, may correspond to only the positive electrode or both the positive electrode and the negative electrode from the viewpoint of further improving the cycle characteristics.

The conductive material is a substance that may also be referred to as a “conductive assistant”. The conductive material is not particularly limited, and examples thereof can include at least one selected from carbon black such as thermal black, furnace black, channel black, ketjen black, and acetylene black; carbon fibers such as graphite, carbon nanotubes, and vapor-grown carbon fibers; metal powders such as copper, nickel, aluminum, and silver; and polyphenylene derivatives. In a more preferred embodiment, the conductive material of the electrode (in particular, the positive electrode) is carbon black (in particular, Ketjen black).

The average primary particle diameter of the conductive material is not particularly limited, and is, for example, 10 nm or more and 100 nm or less.

In the present specification, in an embodiment, the average primary particle diameter is an average value calculated by observing the conductive material with an electron microscope and measuring lengths of 50 randomly selected particles. In a microscopic image, a line is drawn from an end portion to another end portion of each particle, and the distance between two points having the maximum length is defined as the particle diameter.

The conductive material may be formed of primary particles and/or secondary particles in which a plurality of primary particles are aggregated. The fact that at least a part of the conductive material is covered with a covering material means that in the conductive material in such a particle form, the covering material is present in partial or total contact with at least a part of the primary particle surface. For example, the covering material of the conductive material may be present on at least a part of the surface of the primary particles and/or at least a part of voids between the primary particles in the conductive material.

The covering material of the conductive material contains following materials X and Y or a mixture thereof. The covering material may preferably contain the material X, and more preferably be composed only of the material X from the viewpoint of further improving the cycle characteristics.

The material X is a reactant containing at least a first metal alkoxide containing no metal atom-carbon atom bond in one molecule and a second metal alkoxide containing one or more metal atom-carbon atom bonds in one molecule, and is a material also referred to as an “organic-inorganic hybrid material”.

In the present disclosure, the material X is a reactant containing at least a first metal alkoxide and a second metal alkoxide as monomer components. Specifically, in the present disclosure, the material X as a covering material is not formed by stacking a plurality of layers formed of each of the metal alkoxides, but has a network structure (single layer structure) formed of a reactant of a mixture of the metal alkoxides. Because the material X has a moderately rough network structure, it has more sufficient flexibility. The material X further has more sufficient close contact to the conductive material. Therefore, it is considered that the material X has more sufficient strength, and as a result, peeling of the coating is more sufficiently prevented when repeated charging and discharging are performed, and the cycle characteristics improves. When the material X does not contain at least one of the first metal alkoxide and the second metal alkoxide, the material does not have sufficient flexibility and/or does not have sufficient close contact to the conductive material. For this reason, the material does not have sufficient strength, and relatively easily peels off due to repeated charging and discharging, and cycle characteristics deteriorate. The material X may contain unreacted first metal alkoxide and second metal alkoxide in a part thereof.

The first metal alkoxide is a metal alkoxide containing no metal atom-carbon atom bond in one molecule, and is a metal alkoxide in which all hands of the metal are bound to an alkoxy group (—OR¹). In the first metal alkoxide, the metal atom-carbon atom bond is a direct covalent bond between a metal atom and a carbon atom. In the first metal alkoxide, the carbon atom constituting the metal atom-carbon atom bond is a carbon atom constituting a monovalent hydrocarbon group (for example, an alkyl group or an alkenyl group.) or a carbon atom constituting a divalent hydrocarbon group (for example, an alkylene group). The first metal alkoxide does not have such a metal atom-carbon atom bond in one molecule. Therefore, the first metal alkoxide has relatively high reactivity, and mainly fixes the material X to the conductive material by relatively strong bonding at the interface between the material X and the conductive material.

The first metal alkoxide is specifically a compound represented by the following general formula (1).

M¹(OR¹)ₓ (1)

In the formula (1), M¹ is a metal atom and is Si, Ti, Al or Zr, and is preferably Si or Ti and more preferably Si from the viewpoint of further improving the cycle characteristics.

x is the valence of M¹. When M¹ is Si, Ti or Zr, x is 4. When M¹ is Al, x is 3.

R¹s each independently are an alkyl group having 1 to 10 carbon atoms or a group represented by the general formula: —C(R²)═CH—CO—R³ (wherein R² and R³ are as described below), and is preferably an alkyl group having 1 to 5 carbon atoms, and more preferably an alkyl group having 1 to 3 carbon atoms from the viewpoint of further improving the cycle characteristics. Examples of the alkyl group as R¹ include a methyl group, an ethyl group, n-propyl, an isopropyl group, a n-butyl group, an isobutyl group, a sec-butyl group, a tert-butyl group, a n-pentyl group, a n-hexyl group, a n-heptyl group, a n-octyl group, a n-nonyl group, and a n-decyl group. For a plurality of R¹s according to the number of x, all R¹s each independently may be selected from the above-described alkyl groups, or all R¹s may be mutually the same group selected from the above-described alkyl groups.

R² is an alkyl group having 1 to 10 carbon atoms, and is preferably an alkyl group having 1 to 5 carbon atoms from the viewpoint of further improving the cycle characteristics. Examples of the alkyl group as R² include the same alkyl groups as R¹.

R³ is an alkyl group having 1 to 30 carbon atoms, an alkyloxy group having 1 to 30 carbon atoms, or an alkenyloxy group having 1 to 30 carbon atoms, and is preferably an alkyl group having 1 to 20 (more preferably 1 to 10, further preferably 1 to 5) carbon atoms, an alkyloxy group having 10 to 30 (particularly 14 to 24) carbon atoms, or an alkenyloxy group having 10 to 30 (particularly 14 to 24) carbon atoms from the viewpoint of further improving the cycle characteristics. Preferable examples of the alkyl group as R³ include the same alkyl groups as R¹, and an undecyl group, a lauryl group, a tridecyl group, a myristyl group, a pentadecyl group, a cetyl group, a heptadecyl group, a stearyl group, a nonadecyl group, and an eicosyl group. Examples of the alkyloxy group as R³ include a group represented by the formula: —O—CₚH₂ₚ₊₁ (wherein p is an integer of 1 to 30). Examples of the alkenyloxy group as R³ include a group represented by the formula: —O—C_{g}H_{2q-1} (wherein q is an integer of 1 to 30).

In the formula (1), two adjacent R¹s among the plurality of R¹s may be bound to each other to form one ring (for example, a 5- to 8-membered ring, in particular a 6-membered ring) together with an oxygen atom to which the two R¹s are bound and an M¹ atom to which the oxygen atom is bound when the two R¹s are the alkyl groups. Examples of the one ring formed by bonding two adjacent R¹s to each other include a 6-membered ring represented by a general formula (1X).

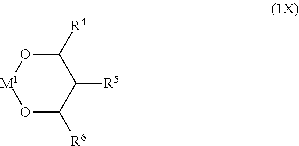

In the formula (1X), R⁴, R⁵, and R⁶ each independently are a hydrogen atom or an alkyl group having 1 to 10 carbon atoms, and are preferably a hydrogen atom or an alkyl group having 1 to 5 carbon atoms from the viewpoint of further improving the cycle characteristics. The total number of carbon atoms of R⁴, R⁵, and R⁶ is usually 0 to 12, and is preferably 2 to 8 from the viewpoint of further improving the cycle characteristics. In the formula (1X), examples of the alkyl group as R⁴, R⁵, and R⁶ include the same alkyl groups as R¹.

Examples of the first metal alkoxide include compounds represented by the following general formulas (1A), (1B), (1B′), (1C), and (1D). The first metal alkoxide is preferably a compound represented by the general formula (1A), (1B), (1C) or (1D) or a mixture thereof, more preferably a compound represented by the general formula (1A) or (1B) or a mixture thereof, and further preferably a compound represented by the general formula (1A) or a mixture thereof, from the viewpoint of further improving the cycle characteristics.

Si(OR¹)₄ (1A)

In the formula (1A), R¹s each independently are the same as R¹s in the formula (1). R¹s each independently are preferably an alkyl group having 1 to 10 carbon atoms, and more preferably an alkyl group having 1 to 5 carbon atoms from the viewpoint of further improving the cycle characteristics.

Specific examples of the compound (1A) represented by such a general formula are shown in the following table.

TABLE 1
Specific examples of Compound (1A)

| Compound | R¹ | R¹ | R¹ | R¹ |
|---|---|---|---|---|
| 1A-1 | Ethyl group | Ethyl group | Ethyl group | Ethyl group |
| 1A-2 | Methyl group | Methyl group | Methyl group | Methyl group |
| 1A-3 | Butyl group | Butyl group | Butyl group | Butyl group |
| 1A-4 | Isopropyl group | Isopropyl group | Isopropyl group | Isopropyl group |

Ti(OR¹)₄ (1B)

In the formula (1B), R¹s each independently are the same as R¹s in the formula (1). R¹s each independently are preferably an alkyl group having 1 to 10 carbon atoms or a group represented by the general formula: —C(R²)═CH—CO—R³ (wherein R² and R³ are the same as R² and R³ described in the general formula (1), respectively), and more preferably an alkyl group having 1 to 10 carbon atoms (particularly 1 to 5) from the viewpoint of further improving the cycle characteristics.

In the formula (1B), R² and R³ are each preferably the following group from the viewpoint of further improving the cycle characteristics. R² is an alkyl group having 1 to 10 carbon atoms, preferably an alkyl group having 1 to 5 carbon atoms. Examples of the alkyl group as R² include the same alkyl groups as R¹. R³ is an alkyl group having 1 to 30 carbon atoms, and preferably an alkyl group having 1 to 20 (more preferably 1 to 10, further preferably 1 to 5) carbon atoms. Preferable examples of the alkyl group as R³ include the same alkyl groups as R¹, and an undecyl group, a lauryl group, a tridecyl group, a myristyl group, a pentadecyl group, a cetyl group, a heptadecyl group, a stearyl group, a nonadecyl group, and an eicosyl group.

Specific examples of the compound (1B) represented by such a general formula are shown in the following table.

TABLE 2
Specific examples of Compound (1B)

| Compound | R¹ | R¹ | R¹ | R¹ |
|---|---|---|---|---|
| 1B-1 | Butyl group | Butyl group | Butyl group | Butyl group |
| 1B-2 | Isopropyl group | Isopropyl group | Isopropyl group | Isopropyl group |
| 1B-3 | Ethyl group | Ethyl group | Ethyl group | Ethyl group |
| 1B-4 | Methyl group | Methyl group | Methyl group | Methyl group |
| 1B-5 | Isopropyl group | Isopropyl group | —C(CH₃)═CH—CO—CH₃ | —C(CH₃)═CH—CO—CH₃ |
| 1B-6 | Isopropyl group | Isopropyl group | —C(CH₃)═CH—CO—C₂H₅ | —C(CH₃)═CH—CO—C₂H₅ |
| 1B-7 | Butyl group | Butyl group | —C(CH₃)═CH—CO—CH₃ | —C(CH₃)═CH—CO—CH₃ |
| 1B-8 | Butyl group | Butyl group | —C(CH₃)═CH—CO—C₂H₅ | —C(CH₃)═CH—CO—C₂H₅ |
| 1B-9 | Ethyl group | Ethyl group | —C(CH₃)═CH—CO—CH₃ | —C(CH₃)═CH—CO—CH₃ |
| 1B-10 | Ethyl group | Ethyl group | —C(CH₃)═CH—CO—C₂H₅ | —C(CH₃)═CH—CO—C₂H₅ |
| 1B-11 | Methyl group | Methyl group | —C(CH₃)═CH—CO—CH₃ | —C(CH₃)═CH—CO—CH₃ |
| 1B-12 | Methyl group | Methyl group | —C(CH₃)═CH—CO—C₂H₅ | —C(CH₃)═CH—CO—C₂H₅ |

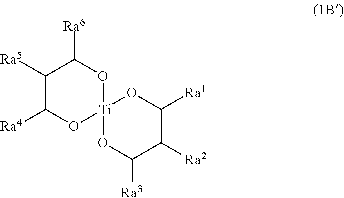

In the formula (1B′), Ra¹, Ra², Ra³, Ra⁴, Ra⁵, and Ra⁶ each independently are a hydrogen atom or an alkyl group having 1 to 10 carbon atoms, and are preferably each independently an alkyl group having 1 to 5 carbon atoms from the viewpoint of further improving the cycle characteristics. Examples of the alkyl group as Ra¹, Ra², Ra³, Ra⁴, Ra⁵, and Ra⁶ are the same as the examples of the alkyl group as R¹.

Specific examples of the compound (1B′) represented by such a general formula are shown in the following table.

TABLE 3
Specific examples of Compound (1B′)

| Compound | Ra¹ | Ra² | Ra³ | Ra⁴ | Ra⁵ | Ra⁶ |
|---|---|---|---|---|---|---|
| 1B-1′ | n-Propyl | Ethyl | Hydrogen | n-Propyl | Ethyl | Hydrogen |
| | group | group | atom | group | group | atom |

Al(OR¹)₃ (1c)

In the formula (1C), R¹s each independently are the same as R¹s in the formula (1). R¹s each independently are preferably an alkyl group having 1 to 10 carbon atoms or a group represented by the general formula: —C(R²)═CH—CO—R³ (wherein R² and R³ are the same as R² and R³ described in the general formula (1), respectively), and more preferably an alkyl group having 1 to 10 (particularly 1 to 5) carbon atoms from the viewpoint of further improving the fillability and load characteristics of the positive electrode active material cycle characteristics.

In the formula (1C), R² and R³ are each preferably the following group from the viewpoint of further improving the cycle characteristics. R² is an alkyl group having 1 to 10 carbon atoms, preferably an alkyl group having 1 to 5 carbon atoms. Examples of the alkyl group as R² include the same alkyl groups as R¹. R³ is an alkyloxy group having 1 to 30 carbon atoms or an alkenyloxy group having 1 to 30 carbon atoms, and is preferably an alkyloxy group having 10 to 30 (particularly 14 to 24) carbon atoms or an alkenyloxy group having 10 to 30 (particularly 14 to 24) carbon atoms. Examples of the alkyloxy group as R³ include a group represented by the formula: —O—CₚH₂ₚ₊₁ (wherein p is an integer of 1 to 30). Examples of the alkenyloxy group as R³ include a group represented by the formula: —O—C_{g}H_{2q-1} (wherein q is an integer of 1 to 30).

Specific examples of the compound (1C) represented by such a general formula are shown in the following table.

TABLE 4
Specific examples of Compound (1C)

| Compound | R¹ | R¹ | R¹ |
|---|---|---|---|
| 1C-1 | Isopropyl group | Isopropyl group | Isopropyl group |
| 1C-2 | Sec-butyl group | Sec-butyl group | Sec-butyl group |
| 1C-3 | Ethyl group | Ethyl group | Ethyl group |
| 1C-4 | Methyl group | Methyl group | Methyl group |
| 1C-5 | Isopropyl group | Isopropyl group | —C(CH₃)═CH—CO—C₁₈H₃₅ |
| 1C-6 | Isopropyl group | Isopropyl group | —C(CH₃)═CH—CO—C₁₈H₃₇ |
| 1C-7 | Sec-butyl group | Sec-butyl group | —C(CH₃)═CH—CO—C₁₈H₃₅ |
| 1C-8 | Sec-butyl group | Sec-butyl group | —C(CH₃)═CH—CO—C₁₈H₃₇ |
| 1C-9 | Ethyl group | Ethyl group | —C(CH₃)═CH—CO—C₁₈H₃₅ |
| 1C-10 | Ethyl group | Ethyl group | —C(CH₃)═CH—CO—C₁₈H₃₇ |
| 1C-11 | Methyl group | Methyl group | —C(CH₃)═CH—CO—C₁₈H₃₅ |
| 1C-12 | Methyl group | Methyl group | —C(CH₃)═CH—CO—C₁₈H₃₇ |

Zr(OR¹)₄ (1D))

In the formula (1D), R¹s each independently are the same as R¹s in the formula (1). R¹s each independently are preferably an alkyl group having 1 to 10 carbon atoms, and more preferably an alkyl group having 1 to 5 carbon atoms from the viewpoint of further improving the cycle characteristics.

Specific examples of the compound (1D) represented by such a general formula are shown in the following table.

TABLE 5
Specific examples of Compound (1D)

| Compound | R¹ | R¹ | R¹ | R¹ |
|---|---|---|---|---|
| 1D-1 | Isopropyl group | Isopropyl group | Isopropyl group | Isopropyl group |
| 1D-2 | Butyl group | Butyl group | Butyl group | Butyl group |
| 1D-3 | Ethyl group | Ethyl group | Ethyl group | Ethyl group |
| 1D-4 | Methyl group | Methyl group | Methyl group | Methyl group |

The compound (1) represented by the general formula (1) can be obtained as a commercially available product, or can be produced by a known method.

For example, the compound (1A) can be obtained as a commercially available tetraethyl orthosilicate (manufactured by Tokyo Chemical Industry Co., Ltd.).

For example, the compound (1B) can be obtained as commercially available tetrabutyl orthotitanate (manufactured by Tokyo Chemical Industry Co., Ltd.) or T-50 (manufactured by Nippon Soda Co., Ltd.).

For example, the compound (1B′) can be obtained as commercially available TOG (manufactured by Nippon Soda Co., Ltd.).

For example, the compound (1C) can be obtained as commercially available aluminum triisopropoxide (manufactured by KANTO CHEMICAL CO., INC.).

For example, the compound (1D) can be obtained as commercially available zirconium(IV) tetrabutoxide (product name: TBZR, manufactured by Nippon Soda Co., Ltd.) or ZR-181 (manufactured by Nippon Soda Co., Ltd.).

The content of the first metal alkoxide in the material X is usually 1 wt % or more and 99 wt % or less with respect to the total weight thereof (for example, the total weight of the first metal alkoxide and the second metal alkoxide), and the content is preferably 5 wt % or more and 95 wt % or less from the viewpoint of further improving the cycle characteristics The material X may contain two or more kinds of first metal alkoxides, and in that case, the total amount thereof may be within the above range. The content of the first metal alkoxide in the material X may be a proportion of the blending amount of the first metal alkoxide to the total blending amount of the first metal alkoxide and the second metal alkoxide.

The second metal alkoxide is a metal alkoxide containing one or more (in particular, two or more, for example, 2 or more and 20 or less, particularly 2 or more and 12 or less) metal atom-carbon atom bonds in one molecule. In the second metal alkoxide, the carbon atom constituting one or more (in particular, two or more) metal atom-carbon atom bonds is a carbon atom constituting a monovalent hydrocarbon group (for example, an alkyl group or an alkenyl group) and/or a carbon atom constituting a divalent hydrocarbon group (for example, an alkylene group). In the second metal alkoxide, the carbon atoms constituting all of one or more (in particular, two or more) metal atom-carbon atom bonds are preferably carbon atoms constituting a divalent hydrocarbon group (for example, an alkylene group) from the viewpoint of further improving the cycle characteristics. The metal atom of the second metal alkoxide is preferably silicon from the viewpoint of further improving the cycle characteristics. The second metal alkoxide contains one or more (in particular, two or more) such metal atom-carbon atom bonds in one molecule. Therefore, the second metal alkoxide prevents formation of a dense network structure, and forms the material X with a moderately rough network structure having flexibility. Specifically, for example, when the carbon atom constituting the metal atom-carbon atom bond is a carbon atom constituting a divalent hydrocarbon group (for example, an alkylene group) in the second metal alkoxide, the “flexibility” and “moderately rough” of the material X are preferably based on a divalent hydrocarbon group 30 of the second metal alkoxide from the viewpoint of further improving the cycle characteristics. As a result, it is considered that in the conductive material of the present disclosure, ion conductivity when ions (in particular, lithium ions) responsible for electron transfer permeate the material X sufficiently improves). When the material X does not contain the second metal alkoxide, the material X has a relatively dense network structure, and cycle characteristics deteriorate.

When the carbon atom constituting the metal atom-carbon atom bond in the second metal alkoxide is a carbon atom constituting a divalent hydrocarbon group, the preferred second metal alkoxide is a compound having two or more trialkoxysilyl groups represented by the following general formula (2) in one molecule.

—Si(OR²¹)₃ (2)

In the formula (2), R²¹s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Examples of such an alkyl group include a methyl group, an ethyl group, n-propyl, an isopropyl group, a n-butyl group, an isobutyl group, a sec-butyl group, a tert-butyl group, a n-pentyl group, a n-hexyl group, a n-heptyl group, a n-octyl group, a n-nonyl group, and a n-decyl group. For a plurality of R²¹s, all R²¹s each independently may be selected from the above-described alkyl groups, or all R²¹s may be mutually the same group selected from the above-described alkyl groups.

The trialkoxysilyl groups of the second metal alkoxide each independently may be selected from the trialkoxysilyl groups of the general formula (2), or may be mutually the same group.

Specific examples of the trialkoxysilyl group represented by the general formula (2) are shown in the following table.

TABLE 6
Specific examples of group of general formula (2)

| Compound | R²¹ | R²¹ | R²¹ |
|---|---|---|---|
| 2A-1 | Methyl group | Methyl group | Methyl group |
| 2A-2 | Ethyl group | Ethyl group | Ethyl group |
| 2A-3 | Isopropyl group | Isopropyl group | Isopropyl group |
| 2A-4 | Butyl group | Butyl group | Butyl group |

When all carbon atoms constituting two or more metal atom-carbon atom bonds in the second metal alkoxide are carbon atoms constituting a divalent hydrocarbon group, the second metal alkoxide may be, for example, a compound represented by the following general formula (2A), (2B), (2C), (2E) or (2F) or a mixture thereof. Among them, the second metal alkoxide is preferably a compound represented by the general formula (2A), (2B) or (2C) or a mixture thereof, more preferably a compound represented by the general formula (2A) or (2B) or a mixture thereof, and further preferably a compound represented by the general formula (2A) from the viewpoint of further improving the cycle characteristics.

When all carbon atoms constituting two or more metal atom-carbon atom bonds in the second metal alkoxide are carbon atoms constituting a monovalent hydrocarbon group, the second metal alkoxide may be, for example, a compound represented by the following general formula (2D) or a mixture thereof.

In the formula (2A), R²¹¹s and R²¹²s each independently are the same groups as R²1 in the formula (2). Specifically, three R²¹¹s and three R²¹²s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Three R²¹¹s and three R²¹²s each independently may be selected from R²1 of the general formula (2), or may be mutually the same group.

R³¹ may be a divalent hydrocarbon group having 1 to 20 carbon atoms, preferably a divalent hydrocarbon group having 1 to 10 carbon atoms, and more preferably a divalent hydrocarbon group having 2 to 8 carbon atoms from the viewpoint of further improving the cycle characteristics. The divalent hydrocarbon group as R³1 may be a divalent saturated aliphatic hydrocarbon group (for example, an alkylene group) or a divalent unsaturated aliphatic hydrocarbon group (for example, an alkenylene group). The divalent hydrocarbon group as R³1 is preferably a divalent saturated aliphatic hydrocarbon group (in particular, an alkylene group) from the viewpoint of further improving the cycle characteristics. Examples of the divalent saturated aliphatic hydrocarbon group (in particular, an alkylene group) as R³¹ include a group represented by —(CH₂)ₚ— (wherein p is an integer of 1 to 10, more preferably 2 to 8).

Specific examples of the compound (2A) represented by such a general formula are shown in the following table.

TABLE 7
Specific examples of group of general formula (2A)

| Compound | R²¹¹ | R²¹¹ | R²¹¹ | R³¹ | R²¹² | R²¹² | R²¹² |
|---|---|---|---|---|---|---|---|
| 2A-1 | Methyl | Methyl | Methyl | —CH₂CH₂— | Methyl | Methyl | Methyl |
| | group | group | group | | group | group | group |
| 2A-2 | Methyl | Methyl | Methyl | —CH₂CH₂CH₂CH₂CH₂CH₂— | Methyl | Methyl | Methyl |
| | group | group | group | | group | group | group |
| 2A-3 | Ethyl | Ethyl | Ethyl | —CH₂CH₂— | Ethyl | Ethyl | Ethyl |
| | group | group | group | | group | group | group |
| 2A-4 | Ethyl | Ethyl | Ethyl | —CH₂CH₂CH₂CH₂CH₂CH₂— | Ethyl | Ethyl | Ethyl |
| | group | group | group | | group | group | group |

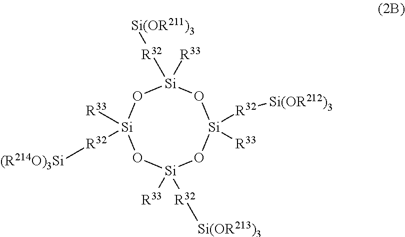

In the formula (2B), R²¹¹s, R²¹²s, R²¹³s, and R²¹⁴s are the same groups as R²¹ in the formula (2). Specifically, three R²¹¹s, three R²¹²s, three R²¹³s, and three R²¹⁴s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Three R²¹¹s, three R²¹²s, three R²¹³s, and three R²¹⁴s each independently may be selected from R²¹ of the general formula (2), or may be mutually the same group.

R³²s each independently are a divalent hydrocarbon group having 1 to 20 carbon atoms, preferably a divalent hydrocarbon group having 1 to 10 carbon atoms, and more preferably a divalent hydrocarbon group having 6 to 10 carbon atoms from the viewpoint of further improving the cycle characteristics. The divalent hydrocarbon group as R³² may be a divalent saturated aliphatic hydrocarbon group (for example, an alkylene group) or a divalent unsaturated aliphatic hydrocarbon group (for example, an alkenylene group). The divalent hydrocarbon group as R³² is preferably a divalent saturated aliphatic hydrocarbon group (in particular, an alkylene group) from the viewpoint of further improving the cycle characteristics. Examples of the divalent saturated aliphatic hydrocarbon group (in particular, an alkylene group) as R³² include a group represented by —(CH₂)_{q}— (wherein q is an integer of 1 to 10, more preferably an integer of 6 to 10). All R³²s each independently may be selected from these R³², or may be mutually the same group.

R³³s each independently are a monovalent hydrocarbon group having 1 to 10 carbon atoms, preferably a monovalent hydrocarbon group having 1 to 5 carbon atoms, and more preferably a monovalent hydrocarbon group having 1 to 3 carbon atoms from the viewpoint of further improving the cycle characteristics. The monovalent hydrocarbon group as R³³ may be a saturated aliphatic hydrocarbon group (for example, an alkyl group) or an unsaturated aliphatic hydrocarbon group (for example, an alkenyl group). The monovalent hydrocarbon group as R³³ is preferably a saturated aliphatic hydrocarbon group (in particular, an alkyl group) from the viewpoint of further improving the cycle characteristics. Examples of the monovalent saturated aliphatic hydrocarbon group (in particular, an alkyl group) as R³³ include a methyl group, an ethyl group, n-propyl, an isopropyl group, a n-butyl group, an isobutyl group, a sec-butyl group, a tert-butyl group, a n-pentyl group, a n-hexyl group, a n-heptyl group, a n-octyl group, a n-nonyl group, and a n-decyl group. All R³³s each independently may be selected from these R³³, or may be mutually the same group.

Specific examples of the compound (2B) represented by such a general formula are shown in the following table.

TABLE 8
Specific examples of group of general formula (2B)

| | Three R²¹¹s, three | | |
|---|---|---|---|
| | R²¹²s, three R²¹³s, | | |
| Compound | three R²¹⁴s | Four R³²s | Four R³³s |
| 2B-1 | Methyl group | —CH₂CH₂CH₂CH₂CH₂CH₂CH₂CH₂— | Methyl group |
| 2B-2 | Ethyl group | —CH₂CH₂CH₂CH₂CH₂CH₂CH₂CH₂— | Methyl group |

(R²¹¹O)₃Si—R³⁴—NH—R³⁵—NH—R³⁸—Si(OR²¹²)₃ (2 C)

In the formula (2C), R²¹¹s and R²¹²s are the same groups as R²¹ in the formula (2). Specifically, three R²¹¹s and three R²¹²s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Three R²¹¹s and three R²¹²s each independently may be selected from R²1 of the general formula (2), or may be mutually the same group.

R³⁴, R³⁵, and R³⁶ each independently are a divalent hydrocarbon group having 1 to 10 carbon atoms, and preferably a divalent hydrocarbon group having 1 to 5 carbon atoms from the viewpoint of further improving the cycle characteristics. The divalent hydrocarbon group as R³⁴, R³⁵, or R³⁶ may be a divalent saturated aliphatic hydrocarbon group (for example, an alkylene group), or may be a divalent unsaturated aliphatic hydrocarbon group (for example, an alkenylene group). The divalent hydrocarbon group as R³⁴, R³⁵, or R³⁶ is preferably a divalent saturated aliphatic hydrocarbon group (in particular, an alkylene group) from the viewpoint of further improving the cycle characteristics. Examples of the divalent saturated aliphatic hydrocarbon group (in particular, an alkylene group) as R³⁴, R³⁵, or R³⁶ include a group represented by —(CH₂)ᵣ— (wherein r is an integer of 1 to 10, more preferably an integer of 1 to 5). All of R³⁴, R³⁵, and R³⁶ each independently may be selected from the divalent hydrocarbon groups described above, or may be mutually the same group. The total number of carbon atoms of R³⁴, R³⁵, and R³⁶ is preferably 3 to 20, and more preferably 6 to 10 from the viewpoint of further improving the cycle characteristics.

Specific examples of the compound (2C) represented by such a general formula are shown in the following table.

TABLE 9
Specific examples of Compound (2C)

| Compound | Three R²¹¹s, three R²¹²s | R³⁴ | R³⁵ | R³⁶ |
|---|---|---|---|---|
| 2C-1 | Methyl group | —CH₂CH₂CH₂— | —CH₂CH₂— | —CH₂CH₂CH₂— |
| 2C-2 | Ethyl group | —CH₂CH₂CH₂— | —CH₂CH₂— | —CH₂CH₂CH₂— |

(R²¹¹)₂—Si(OR²¹²)₂ (2D)

In the formula (2D), R²¹¹s and R²¹²s each independently are the same group as R²¹ in the formula (2). Specifically, two R²¹¹s and two R²¹²s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Two R²¹¹s and two R²¹²s each independently may be selected from R²¹ of the general formula (2), or may be mutually the same group.

Specific examples of the compound (2D) represented by such a general formula are shown in the following table.

TABLE 10
Specific examples of Compound (2D)

| Compound | Two R²¹¹s | Two R²¹²s |
|---|---|---|
| 2D-1 | Methyl group | Methyl group |
| 2D-2 | Methyl group | Ethyl group |

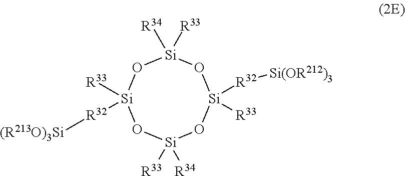

In the formula (2E), R²¹²s and R²¹³s are the same groups as R²¹ in the formula (2). Specifically, three R²¹²s and three R²¹³s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Three R²¹²s and three R²¹³s each independently may be selected from R²¹ of the general formula (2), or may be mutually the same group.

R³²s each independently are a divalent hydrocarbon group having 1 to 20 carbon atoms, preferably a divalent hydrocarbon group having 1 to 10 carbon atoms, and more preferably a divalent hydrocarbon group having 4 to 8 carbon atoms from the viewpoint of further improving the cycle characteristics. The divalent hydrocarbon group as R³² may be a divalent saturated aliphatic hydrocarbon group (for example, an alkylene group) or a divalent unsaturated aliphatic hydrocarbon group (for example, an alkenylene group). The divalent hydrocarbon group as R³² is preferably a divalent saturated aliphatic hydrocarbon group (in particular, an alkylene group) from the viewpoint of further improving the cycle characteristics. Examples of the divalent saturated aliphatic hydrocarbon group (in particular, an alkylene group) as R³² include a group represented by —(CH₂)_{q}— (wherein q is an integer of 1 to 20, preferably an integer of 1 to 10, more preferably an integer of 4 to 8). All R³²s each independently may be selected from these R³², or may be mutually the same group.

R³³s each independently are a monovalent hydrocarbon group having 1 to 10 carbon atoms, preferably a monovalent hydrocarbon group having 1 to 5 carbon atoms, and more preferably a monovalent hydrocarbon group having 1 to 3 carbon atoms from the viewpoint of further improving the cycle characteristics. The monovalent hydrocarbon group as R³³ may be a saturated aliphatic hydrocarbon group (for example, an alkyl group) or an unsaturated aliphatic hydrocarbon group (for example, an alkenyl group). The monovalent hydrocarbon group as R³³ is preferably a saturated aliphatic hydrocarbon group (in particular, an alkyl group) from the viewpoint of further improving the cycle characteristics. Examples of the monovalent saturated aliphatic hydrocarbon group (in particular, an alkyl group) as R³³ include a methyl group, an ethyl group, n-propyl, an isopropyl group, a n-butyl group, an isobutyl group, a sec-butyl group, a tert-butyl group, a n-pentyl group, a n-hexyl group, a n-heptyl group, a n-octyl group, a n-nonyl group, and a n-decyl group. All R³³s each independently may be selected from these R³³, or may be mutually the same group.

R³⁴s each independently are a monovalent hydrocarbon group having 1 to 30 carbon atoms, preferably a monovalent hydrocarbon group having 1 to 10 carbon atoms, and more preferably a monovalent hydrocarbon group having 1 to 5 carbon atoms from the viewpoint of further improving the cycle characteristics. The monovalent hydrocarbon group as R³⁴ may be a saturated aliphatic hydrocarbon group (for example, an alkyl group) or an unsaturated aliphatic hydrocarbon group (for example, an alkenyl group). The monovalent hydrocarbon group as R³⁴ is preferably a saturated aliphatic hydrocarbon group (in particular, an alkyl group) from the viewpoint of further improving the cycle characteristics. Examples of the monovalent saturated aliphatic hydrocarbon group (in particular, an alkyl group) as R³⁴ include a methyl group, an ethyl group, -propyl, an isopropyl group, a n-butyl group, an isobutyl group, a sec-butyl group, a tert-butyl group, a n-pentyl group, a n-hexyl group, a n-heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an eicosyl group. All R³⁴s each independently may be selected from these R³⁴, or may be mutually the same group.

Specific examples of the compound (2E) represented by such a general formula are shown in the following table.

TABLE 11
Specific examples of Compound (2E)

| | Three R²¹²s, three | | | |
|---|---|---|---|---|
| Compound | R²¹³s | Two R³²s | Four R³³s | Two R³⁴s |
| 2E-1 | Methyl group | —CH₂CH₂CH₂CH₂CH₂CH₂— | Methyl | Ethyl |
| | | | group | group |
| 2E-2 | Ethyl group | —CH₂CH₂CH₂CH₂CH₂CH₂— | Methyl | Ethyl |
| | | | group | group |

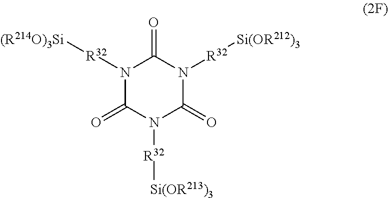

In the formula (2F), R²¹²s, R²¹³s and R²¹⁴s each independently are the same groups as R²¹ in the formula (2). Specifically, three R²¹²s, three R²¹³s, and three R²¹⁴s each independently are an alkyl group having 1 to 10 carbon atoms, preferably an alkyl group having 1 to 5 carbon atoms, and more preferably an alkyl group having 1 to 3 carbon atoms from the viewpoint of further improving the cycle characteristics. Three R²¹²s, three R²¹³s, and three R²¹⁴s each independently may be selected from R²¹ of the general formula (2), or may be mutually the same group.

R³²s each independently are a divalent hydrocarbon group having 1 to 20 carbon atoms, preferably a divalent hydrocarbon group having 1 to 10 carbon atoms, and more preferably a divalent hydrocarbon group having 1 to 5 carbon atoms from the viewpoint of further improving the cycle characteristics. The divalent hydrocarbon group as R³² may be a divalent saturated aliphatic hydrocarbon group (for example, an alkylene group) or a divalent unsaturated aliphatic hydrocarbon group (for example, an alkenylene group). The divalent hydrocarbon group as R³² is preferably a divalent saturated aliphatic hydrocarbon group (in particular, an alkylene group) from the viewpoint of further improving the cycle characteristics. Examples of the divalent saturated aliphatic hydrocarbon group (in particular, an alkylene group) as R³² include a group represented by —(CH₂)_{q}— (wherein q is an integer of 1 to 10, more preferably an integer of 1 to 5). All R³²s each independently may be selected from these R³², or may be mutually the same group.

Specific examples of the compound (2F) represented by such a general formula are shown in the following table.

TABLE 12
Specific examples of Compound (2F)

| Compound | Three R²¹²s | Three R²¹³s | Three R²¹⁴s | Three R³²s |
|---|---|---|---|---|
| 2F-1 | Methyl group | Methyl group | Methyl group | —CH₂CH₂CH₂— |
| 2F-2 | Ethyl group | Ethyl group | Ethyl group | —CH₂CH₂CH₂— |

The compound (2A) represented by the general formula (2A), the compound (2B) represented by the general formula (2B), the compound (2C) represented by the general formula (2C), the compound (2D) represented by the general formula (2D), the compound (2E) represented by the general formula (2E), and the compound (2F) represented by the general formula (2F) can be obtained as commercially available products, or can be produced by a known method.

For example, the compound (2A) can be obtained as commercially available 1,2-bis(trimethoxysilyl) ethane (manufactured by Tokyo Chemical Industry Co., Ltd.) or 1,6-bis(trimethoxysilyl)hexane (manufactured by Tokyo Chemical Industry Co., Ltd.).

For example, the compound (2C) can be obtained as commercially available X-12-5263HP (manufactured by Shin-Etsu Chemical Co., Ltd.).

For example, the compound (2D) can be obtained as commercially available dimethyldimethoxysilane (manufactured by Tokyo Chemical Industry Co., Ltd.).

For example, the compound (2F) can be obtained as commercially available tris[3-(trimethoxysilyl)-propyl]isocyanurate (manufactured by Tokyo Chemical Industry Co., Ltd.).

The second metal alkoxide may be, for example, a compound represented by the general formula (2A), (2B), (2C), (2D), (2E) or (2F), or a mixture thereof. The second metal alkoxide is preferably a compound represented by the general formula (2A), (2B), (2C) or (2D) or a mixture thereof, and more preferably a compound represented by the general formula (2A) or (2D) or a mixture thereof from the viewpoint of further improving the cycle characteristics.

When the second metal alkoxide is a metal alkoxide containing only one metal atom-carbon atom bond in one molecule, the second metal alkoxide is, for example, an alkoxide compound in which one hand is bonded to a monovalent hydrocarbon group (—R¹²) and all the remaining hands are bonded to an alkoxy group (—OR¹¹) among the hands of the metal. Such a second metal alkoxide is sometimes referred to as a metal alkoxide 2′. In the metal alkoxide 2′, the metal atom-carbon atom bond is a direct covalent bond between a metal atom and a carbon atom. In the metal alkoxide 2′, the carbon atom constituting the metal atom-carbon atom bond is a carbon atom constituting a monovalent hydrocarbon group (for example, an alkyl group or an alkenyl group). The metal alkoxide 2′ contains only one such metal atom-carbon atom bond in one molecule. The metal atom of the metal alkoxide 2′ is silicon. The metal alkoxide 2′ reduces the surface free energy of the material X and imparts more sufficient slipperiness to the surface of the material X. It is considered that such sufficient slipperiness is based on a monovalent hydrocarbon group (for example, R¹² in a general formula (3)) of the metal alkoxide 2′.

The metal alkoxide 2′ is specifically a compound represented by the following general formula (3).

R¹²—Si(OR¹¹)₃ (3)

In the formula (3), R¹¹s each independently are an alkyl group having 1 to 10 carbon atoms, preferably an alkyl group having 1 to 5 carbon atoms, and more preferably an alkyl group having 1 to 3 carbon atoms from the viewpoint of further improving the fillability and the loading characteristics of the positive electrode active material. Examples of such an alkyl group include a methyl group, an ethyl group, n-propyl, an isopropyl group, a n-butyl group, an isobutyl group, a sec-butyl group, a tert-butyl group, a n-pentyl group, a n-hexyl group, a n-heptyl group, a n-octyl group, a n-nonyl group, and a n-decyl group. All R¹¹s each independently may be selected from the above-described alkyl groups, or all R¹¹s may be mutually the same group selected from the above-described alkyl groups.

R¹² is a monovalent hydrocarbon group having 8 to 30 carbon atoms, preferably a monovalent hydrocarbon group having 12 to 24 carbon atoms, and more preferably a monovalent hydrocarbon group having 14 to 20 carbon atoms from the viewpoint of further improving the fillability and load characteristics of the positive electrode active material. The monovalent hydrocarbon group as R¹² may be a saturated aliphatic hydrocarbon group (for example, an alkyl group) or an unsaturated aliphatic hydrocarbon group (for example, an alkenyl group). The monovalent hydrocarbon group as R¹² is preferably a saturated aliphatic hydrocarbon group (in particular, an alkyl group) from the viewpoint of further improving the fillability and the load characteristics of the positive electrode active material. Examples of the monovalent saturated aliphatic hydrocarbon group (in particular, alkyl group) as R¹² include an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an eicosyl group.

Specific examples of the compound (3) represented by such a general formula are shown in the following table.

TABLE 13
Specific examples of Compound (3)

| Compound | R¹² | R¹¹ | R¹¹ | R¹¹ |
|---|---|---|---|---|
| 3A-1 | Octadecyl group | Methyl group | Methyl group | Methyl group |
| 3A-2 | Hexadecyl group | Methyl group | Methyl group | Methyl group |
| 3A-3 | Decyl group | Methyl group | Methyl group | Methyl group |
| 3A-4 | Octadecyl group | Ethyl group | Ethyl group | Ethyl group |
| 3A-5 | Hexadecyl group | Ethyl group | Ethyl group | Ethyl group |
| 3A-6 | Decyl group | Ethyl group | Ethyl group | Ethyl group |

The compound (3) represented by the general formula (3) can be obtained as a commercially available product, or can be produced by a known method.

For example, the compound (3) can be obtained as commercially available product octadecyltrimethoxysilane (manufactured by Tokyo Chemical Industry Co., Ltd.), hexadecyltrimethoxysilane (manufactured by Tokyo Chemical Industry Co., Ltd.), or decyltrimethoxysilane (manufactured by Tokyo Chemical Industry Co., Ltd.).

The content of the second metal alkoxide (particularly the content of the second metal alkoxide other than the metal alkoxide 2′ to be described later) in the material X as a covering material of the conductive material is usually 1 wt % or more and 99 wt % or less with respect to the total weight thereof (for example, the total weight of the first metal alkoxide and the second metal alkoxide), and the content is preferably 5 wt % or more and 95 wt % or less from the viewpoint of further improving the cycle characteristics The material X may contain two or more kinds of second metal alkoxides, and in that case, the total amount thereof may be within the above range. The content of the second metal alkoxide in the material X may be a proportion of the blending amount of the second metal alkoxide to the total blending amount of the first metal alkoxide and the second metal alkoxide.

Material Y is a lithium-containing composite oxide containing Li (lithium) and one or more elements selected from the group consisting of Group 2 elements, transition metal elements, rare earth elements, Group 13 elements, Group 14 elements, and Group 15 elements (hereinafter, sometimes referred to as “group I”).

Examples of the Group 2 element include Mg (magnesium).

Examples of the transition metal element include tungsten (W).

Examples of the rare earth element include Ce (cerium).

Examples of the Group 13 element include Al (aluminum).

Examples of the Group 14 element include B (boron) and Si (silicon).

Examples of the Group 15 element include P (phosphorus).

The lithium-containing composite oxide as the material Y may be, for example, a compound represented by a general formula (4).

LiₐM_{b}O_{c} (4)

In the formula (4), M is one or more elements selected from the group consisting of the group I described above, and from the viewpoint of further improving the cycle characteristics, M is preferably one or more elements selected from the group consisting of transition metal elements, Group 14 elements, and Group 15 elements (hereinafter, sometimes referred to as “group II”), more preferably one or more elements selected from the group consisting of W (tungsten), B (boron), Si (silicon), and P (phosphorus) (hereinafter, sometimes referred to as “group III”), still more preferably one or more elements selected from the group consisting of Group 14 elements, and M particularly preferably contains B (boron), and M most preferably may contain only B (boron).

In the formula (4), a is an integer of 1 or more and 4 or less, and from the viewpoint of further improving the cycle characteristics, a is preferably an integer of 2 or more and 3 or less.

b is an integer of 1 or more and 5 or less, and from the viewpoint of further improving the cycle characteristics, b is preferably an integer of 2 or more and 4 or less. When M is two or more elements, b is the total number of values related to each element.

c is an integer of 2 or more and 8 or less, and from the viewpoint of further improving the cycle characteristics, c is preferably an integer of 3 or more and 7 or less.

Regarding the material Y, specific examples of the compound (4) represented by such a general formula include Li₂B₂O₄, Li₃BO₃, Li₂B₄O₇, and Li₄SiO₄.

The compound (4) represented by the general formula (4) can be obtained as a commercially available product, or can be produced by a known method.

It can be confirmed by microscopic observation that at least a part of the conductive material is covered with the covering material, and specifically, it can be confirmed by STEM-EDX (Scanning Transmission Electron Microscope-Energy Dispersive X-ray Spectrometer)).

The covering on the conductive material with the covering material can be achieved by stirring the conductive material together with a solution containing a predetermined raw material of the covering material, and then removing the solvent. The predetermined raw material of the covering material varies depending on the type of the covering material. For example, when the covering material is material A, the predetermined raw material of the covering material is a predetermined metal alkoxide (contains, for example, at least a first metal alkoxide and a second metal alkoxide, and optionally further contains a metal alkoxide 2′). Further, for example, when the covering material is material B, the predetermined raw material of the covering material is a predetermined lithium-containing composite oxide (for example, the compound represented by the general formula (4)). Furthermore, for example, when the covering material is a composite material of the material A and the material B, the predetermined raw material of the covering material is a mixture of a predetermined metal alkoxide (contains, for example, at least a first metal alkoxide and a second metal alkoxide, and optionally further contains a metal alkoxide 2′) and a predetermined lithium-containing composite oxide (for example, the compound represented by the general formula (4)).

The bonding state of metal atom-carbon atoms in the material X or the material Y contained in the covering material of the conductive material can be confirmed by spectrum analysis by X-ray Photoelectron Spectroscopy (XPS). Therefore, for example, the bonding state of the first and second alkoxide metals can be detected by XPS.

The raw material of the covering material is usually used by being dissolved in a solvent. The solvent is not particularly limited as long as the raw material of the covering material can be dissolved, and may be, for example, ketones, monoalcohols, ethers, glycols, or glycol ethers. In a preferred embodiment, the solvent may be a ketone such as N-methyl-2 pyrrolidone or N-ethyl-2-pyrrolidone; a monoalcohol such as methanol, ethanol, 1-propanol, 2-propanol, 1-butanol, 2-butanol, iso-butyl alcohol, 1-pentanol, 2-pentanol, or 2-methyl-2 pentanol; an ether such as 2-methoxyethanol, 2-ethoxyethanol, or 2-butoxyethanol; a glycol such as ethylene glycol, diethylene glycol, triethylene glycol, and propylene glycol; or a glycol ether such as dipropylene glycol monomethyl ether, diethylene glycol monomethyl ether, diethylene glycol monoethyl ether, diethylene glycol monobutyl ether, triethylene glycol monomethyl ether, or diethylene glycol monohexyl ether. A preferred solvent is a ketone. Also, water may be contained as necessary. The solvent may be used singly, or in combination of two or more kinds thereof. The solvent may contain various additives, for example, a catalyst, a pH adjusting agent, a stabilizer, a thickener, and the like. Examples of the additive include an acid compound such as a boric acid compound and a base compound such as an ammonia compound.

After stirring, specifically, by heating and drying, the solvent is removed, and covering on the conductive material with the covering material is achieved. For example, when the covering material is material X, a dealcoholization reaction of at least the first metal alkoxide and the second metal alkoxide occurs by heating and drying, and the material X having a network structure is formed on the surface of the conductive material. Also, for example, when the covering material is material Y, the solvent is removed by heating and drying, and adhesion of the material Y to the surface of the conductive material is achieved. The covering method is not limited to the above method as long as covering on the conductive material is achieved, and may be performed by a coating method such as spraying or dry mixing. After stirring, the conductive material may be separated by filtration and washed before heating and drying. Washing is performed to remove the remaining catalyst. For example, washing is performed by bringing a residue obtained by filtration into contact with a washing solvent. The washing solvent is not particularly limited, and may be, for example, acetone.

The temperature of the mixture during stirring is not particularly limited as long as the raw material of the covering material can uniformly exist on the surface of the conductive material, and is, for example, 10° C. or more and 70° C. or less, preferably 15° C. or more and 35° C. or less.

The stirring time is not particularly limited either as long as the raw material of the covering material can uniformly exist on the surface of the conductive material, and is, for example, 10 minutes or more and 5 hours or less, preferably 30 minutes or more and 3 hours or less.

In heating and drying, the heating temperature is usually 15° C. or more (particularly 15° C. or more and 250° C. or less), and is preferably 15° C. or more and 200° C. or less from the viewpoint of solvent removal. The heating time is usually 30 minutes or more (particularly 30 minutes or more and 24 hours or less), and is preferably 60 minutes or more and 12 hours or less from the viewpoint of solvent removal.

In the electrode having a conductive material covering structure, the covering amount of the covering material on the conductive material is 0.0008 mmol/m² or more and 0.06 mmol/m² or less, and from the viewpoint of further improving the cycle characteristics, the covering amount is preferably 0.0008 mmol/m² or more and 0.05 mmol/m² or less, more preferably 0.0008 mmol/m² or more and 0.035 mmol/m² or less, and still more preferably 0.0008 mmol/m² or more and 0.015 mmol/m² or less. When the covering amount on the conductive material is too large, a problem that the resistance becomes too large occurs, leading to deterioration of cycle characteristics. On the other hand, when the covering amount is too small, decomposition of the electrolyte on the conductive material is caused, resulting in an increase in resistance due to deposition of by-products thereof, leading to deterioration of cycle characteristics. In the present disclosure, by controlling the covering amount on the conductive material as described above, it is possible to realize a high capacity retention ratio and suppression of a resistance increase ratio after the cycle.

The covering amount of the covering material on the conductive material can be controlled by adjusting the amount of the covering raw material to be dissolved in the solvent.

When the covering material is material X, the total blending amount of the first metal alkoxide and the second metal alkoxide constituting the material X per unit area on the surface area of the conductive material is used as the covering amount of the covering material on the conductive material.

When the covering material is material Y, the total blending amount of the material Y per unit area on the surface area of the conductive material is used as the covering amount of the covering material on the conductive material.

For example, the covering amount of the covering material on the conductive material is calculated by the following formula.

Covering amount of covering material on conductive material [mmol/m²]=A/B

In the above formula, A is calculated by the following formula.

A[mmol]=1000×(covering material content in electrode [g]−covering material content in electrode active material [g])/molecular weight of covering material

B is a surface area [m²] of the conductive material contained in the electrode.

The calculation formula A is a formula when the electrode active material has an electrode active material covering structure as described later, but when the electrode active material does not have an electrode active material covering structure as described later, the covering material content [g] in the electrode active material is 0 in the calculation formula A.

The method for measuring the covering material content in the electrode is not particularly limited, and for example, the covering material content contained in the electrode can be calculated by subjecting the electrode to an inductively coupled plasma atomic emission spectrometer.

The method for measuring the covering material content in the electrode active material is not particularly limited, and for example, the covering material content in the electrode active material can be calculated by the following method.

The electrode is immersed in n-methylpyrrolidone or the like capable of swelling and dissolving the electrode, only the electrode active material is extracted from the electrode, and emission spectroscopic analysis of the electrode active material is performed by the same method as the method for measuring the covering material content in the electrode, thereby calculating the covering material content in the electrode active material.

In the present disclosure, the electrode having a conductive material covering structure may or may not have an electrode active material covering structure in which at least a part of the electrode active material is covered with a covering material. When the electrode having a conductive material covering structure has an electrode active material covering structure and the covering material content in the electrode active material is within a specific range, cycle characteristics can be further improved. For example, when an electrode having a conductive material covering structure is a positive electrode and the positive electrode has an electrode active material covering structure, the electrode active material is a positive electrode active material. Also, for example, when an electrode having a conductive material covering structure is a negative electrode and the negative electrode has an electrode active material covering structure, the electrode active material is a negative electrode active material.

The positive electrode active material is a substance that contributes to occlusion and release of ions that move between the positive electrode and the negative electrode to transfer electrons, and is preferably a substance that contributes to occlusion and release of lithium ions from the viewpoint of increasing the battery capacity. From such a viewpoint, the positive electrode active material may be, for example, a lithium-containing composite oxide. More specifically, the positive electrode active material is preferably a lithium-transition metal composite oxide containing lithium and at least one transition metal selected from the group consisting of cobalt, nickel, manganese, and iron. For example, the positive electrode active material may be lithium cobaltate, lithium nickelate, lithium manganate, lithium iron phosphate, or a material obtained by replacing a part of the transition metal thereof with another metal. Such positive electrode active materials may be contained singly, or in combination of two or more thereof. In a more preferred embodiment, the positive electrode active material core material contained in the positive electrode active material is lithium nickelate (NCA). The average primary particle diameter of the positive electrode active material is not particularly limited, and may be, for example, 1 μm or more and 50 μm or less, particularly 3 μm or more and 30 μm or less.

The negative electrode active material is preferably a material that contributes to occlusion and release of lithium ions. From such a viewpoint, the negative electrode active material may be, for example, various carbon materials, oxides, lithium alloys, or the like. Examples of the various carbon materials for the negative electrode active material include graphite (natural graphite and artificial graphite), hard carbon, soft carbon, and diamond-like carbon. In particular, graphite is preferable because it has high electron conductivity and excellent adhesion to the negative electrode current collector. Examples of the oxide of the negative electrode active material include at least one selected from the group consisting of silicon oxide, tin oxide, indium oxide, zinc oxide, and lithium oxide. The lithium alloy for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La. Such an oxide may be amorphous in its structural form. This is because deterioration due to nonuniformity such as a crystal grain boundary or a defect is less likely to be caused. In a more preferable embodiment, the negative electrode active material of the negative electrode layer is artificial graphite. The average primary particle diameter of the negative electrode active material is not particularly limited, and may be, for example, 1 μm or more and 50 μm or less, particularly 3 μm or more and 30 μm or less.

Similarly to the conductive material, the electrode active material may also be formed of primary particles and/or secondary particles in which a plurality of primary particles are aggregated. The fact that at least a part of the electrode active material is covered with a covering material means that in the electrode active material in such a particle form, the covering material is present in partial or total contact with at least a part of the primary particle surface. For example, the covering material of the electrode active material may be present on at least a part of the surface of the primary particles and/or at least a part of voids between the primary particles in the electrode active material.

The covering material of the electrode active material contains the materials X and Y described above or a mixture thereof. The covering material may preferably contain the material X, and more preferably be composed only of the material X from the viewpoint of further improving the cycle characteristics. The materials X and Y as the covering material of the electrode active material may be selected from the same ranges as the materials X and Y as the covering material of the conductive material described above, respectively. When the electrode having a conductive material covering structure has an electrode active material covering structure, the covering material of the electrode active material is preferably substantially the same material as the covering material of the conductive material from the viewpoint of further improving the cycle characteristics. The fact that the covering material of the electrode active material is substantially the same material as the covering material of the conductive material means that the covering material of the electrode active material and the covering material of the conductive material contain at least one same element derived from the same covering raw material (particularly, contain the same covering raw material).

The contents of the first metal alkoxide and the second metal alkoxide (particularly, the content of the second metal alkoxide other than the metal alkoxide 2′ to be described later) and preferred contents thereof in the material X as the covering material of the electrode active material may be within the same ranges as the contents of the first metal alkoxide and the second metal alkoxide (particularly, the content of the second metal alkoxide other than the metal alkoxide 2′ to be described later) and preferred contents thereof in the material X as the covering material of the conductive material.

It can be confirmed by microscopic observation that at least a part of the electrode active material is covered with the covering material, and specifically, it can be confirmed by STEM-EDX (Scanning Transmission Electron Microscope-Energy Dispersive X-ray Spectrometer)).

The covering on the electrode active material with the covering material can be achieved by the same method as the method for covering the conductive material with the covering material except that the electrode active material is used instead of the conductive material.

In the electrode having an electrode active material covering structure, the covering amount of the covering material on the electrode active material is usually 0.001 mmol/m² or more and 0.40 mmol/m² or less, and from the viewpoint of further improving the cycle characteristics, the covering amount is preferably 0.0025 mmol/m² or more and 0.22 mmol/m² or less, more preferably 0.01 mmol/m² or more and 0.22 mmol/m² or less, and still more preferably 0.03 mmol/m² or more and 0.22 mmol/m² or less. In the present disclosure, by controlling not only the covering amount on the conductive material but also the covering amount on the electrode active material as described above, it is possible to realize more sufficiently high capacity retention ratio and more sufficient resistance increase ratio after the cycle.

The covering amount of the covering material on the electrode active material can be controlled by adjusting the amount of the covering raw material to be dissolved in the solvent.

When the covering material is material X, the total blending amount of the first metal alkoxide and the second metal alkoxide constituting the material X per unit area on the surface area of the electrode active material is used as the covering amount of the covering material on the electrode active material.

When the covering material is material Y, the total blending amount of the material Y per unit area on the surface area of the electrode active material is used as the covering amount of the covering material on the electrode active material.

For example, the covering amount of the covering material on the electrode active material is calculated by the following formula.

Covering amount of covering material on electrode active material [mmol/m²]=C/D

In the above formula, C is calculated by the following formula.

C[mmol]=1000×(covering material content in electrode active material [g])/molecular weight of covering material

D is a surface area [m²] of the electrode active material contained in the electrode.

The method for measuring the covering material content in the electrode is not particularly limited, and for example, the covering material content contained in the electrode can be measured by subjecting the electrode to an inductively coupled plasma atomic emission spectrometer.

The method for measuring the covering material content in the electrode active material is not particularly limited, and the covering material content in the electrode active material can be calculated by the method described above.

When the electrode having a conductive material covering structure has an electrode active material covering structure, covering amount M of the covering material in the conductive material and covering amount N of the covering material in the electrode active material preferably satisfy following relational expression P1, more preferably following relational expression P2, still more preferably following relational expression P3, particularly preferably following relational expression P4, and most preferably following relational expression P5 from the viewpoint of further improving the cycle characteristics.

M/N=0.1/99.9 or more and 95/5 or less: Relational expression P1:

M/N=0.1/99.9 or more and 80/20 or less: Relational expression P2:

M/N=0.1/99.9 or more and 60/40 or less: Relational expression P3:

M/N=0.1/99.9 or more and 40/60 or less: Relational expression P4:

M/N=0.3/99.7 or more and 30/70 or less. Relational expression P5:

The electrodes (positive electrode and negative electrode) of the present disclosure preferably have following Embodiment 1, and more preferably have following Embodiment 2 from the viewpoint of further improving the cycle characteristics. In the following embodiments, the phrase “does not have an electrode active material covering structure” means that the electrode active material is not covered with a covering material, particularly, the electrode active material is not used being covered with a covering material.

In an embodiment, the positive electrode has a conductive material covering structure and does not have an electrode active material covering structure; and
the negative electrode may or may not contain a conductive material, and usually does not contain a conductive material. When the negative electrode contains a conductive material, the negative electrode may or may not have a conductive material covering structure. At this time, the negative electrode may or may not have an electrode active material covering structure, and usually does not have an electrode active material covering structure.

In an embodiment, the positive electrode has a conductive material covering structure and has an electrode active material covering structure; and
the negative electrode may or may not contain a conductive material, and usually does not contain a conductive material. When the negative electrode contains a conductive material, the negative electrode may or may not have a conductive material covering structure. At this time, the negative electrode may or may not have an electrode active material covering structure, and usually does not have an electrode active material covering structure.

Hereinafter, a structure of the secondary battery of the present disclosure will be described in further detail according to an embodiment.

In the secondary battery of the present disclosure, a positive electrode, a negative electrode, a separator disposed between the positive electrode and the negative electrode, and an electrolyte are usually enclosed in an exterior body. In the secondary battery of the present disclosure, the positive electrode, the negative electrode, and the separator disposed between the positive electrode and the negative electrode constitute an electrode assembly. In the secondary battery of the present disclosure, the electrode assembly may have any structure. Examples of the structure that the electrode assembly may have include a stacked structure (planar stacked structure), a wound structure (jelly roll structure), and a stack and folding structure. Specifically, for example, the electrode assembly may have a planar stacked structure in which one or more positive electrodes and one or more negative electrodes are stacked in a planar shape with a separator interposed therebetween. For example, the electrode assembly may also have a wound structure (jelly roll type) in which a positive electrode, a negative electrode, and a separator disposed between the positive electrode and the negative electrode are wound in a roll shape. For example, the electrode assembly may also have a so-called stack and folding structure in which a positive electrode, a separator, and a negative electrode are stacked on a long film and then folded.

The positive electrode is composed of at least a positive electrode layer and a positive electrode current collector (foil). The positive electrode layer usually contains a positive electrode active material and a conductive material. The positive electrode active material and the conductive material of the positive electrode layer are made of, for example, a granular material, and a binder may be contained in the positive electrode layer for sufficient contact between particles and shape retention. As described above, because a plurality of components are contained, the positive electrode layer may also be referred to as “positive electrode mixture layer” or the like.

The positive electrode (particularly the positive electrode layer) preferably has a conductive material covering structure, and may or may not have an electrode active material covering structure.

When the positive electrode (particularly the positive electrode layer) has a conductive material covering structure, a conductive material covered with a covering material by the above-described method is used in the production of the positive electrode (particularly the positive electrode layer).

When the positive electrode (particularly the positive electrode layer) has an electrode active material covering structure, a positive electrode active material covered with a covering material by the above-described method is used in the production of the positive electrode (particularly the positive electrode layer).

When the positive electrode (particularly the positive electrode layer) does not have an electrode active material covering structure, the above-described positive electrode active material that is not covered with a covering material is used as it is in the production of the positive electrode (particularly the positive electrode layer).

The content of the positive electrode active material in the positive electrode layer is usually 50 wt % or more and 98 wt % or less with respect to the total weight of the positive electrode layer, and is preferably 70 wt % or more and 98 wt % or less, and more preferably 80 wt % or more and 98 wt % or less from the viewpoint of further improving the cycle characteristics.

The content of the conductive material in the positive electrode layer is usually 1 wt % or more and 20 wt % or less with respect to the total weight of the positive electrode layer, and is preferably 1 wt % or more and 10 wt % or less, more preferably 1 wt % or more and 8 wt % or less, and still more preferably 2 wt % or more and 8 wt % or less from the viewpoint of further improving the cycle characteristics.

The binder that may be contained in the positive electrode layer is not particularly limited, and examples thereof include at least one selected from the group consisting of polyvinylidene fluoride, vinylidene fluoride-hexafluoropropylene copolymer, vinylidene fluoride-tetrafluoroethylene copolymer, polytetrafluoroethylene, and the like. In a more preferred embodiment, the binder of the positive electrode layer is polyvinylidene fluoride.

The content of the binder in the positive electrode layer is usually 1 wt % or more and 20 wt % or less with respect to the total weight of the positive electrode layer, and is preferably 1 wt % or more and 10 wt % or less, more preferably 1 wt % or more and 8 wt % or less, and still more preferably 2 wt % or more and 8 wt % or less from the viewpoint of further improving the cycle characteristics.

The thickness of the positive electrode layer is not particularly limited, and may be, for example, 1 μm or more and 300 μm or less, particularly 5 μm or more and 200 μm or less. The thickness of the positive electrode layer is the thickness inside the battery (in particular, secondary battery), and an average value of measured values at any 50 points is used.

The positive electrode current collector is a member that contributes to collecting and supplying electrons generated in the active material due to the battery reaction. Such a current collector may be a sheet-like metal member or may have a porous or perforated form. For example, the current collector may be a metal foil, a punching metal, a net, an expanded metal, or the like. The positive electrode current collector used for the positive electrode preferably includes a metal foil containing at least one selected from a group consisting of aluminum, stainless steel, nickel, and the like, and may be, for example, an aluminum foil.

In the positive electrode, the positive electrode layer may be provided on at least one face of the positive electrode current collector. For example, in the positive electrode, the positive electrode layer may be provided on both faces of the positive electrode current collector, or the positive electrode layer may be provided on one face of the positive electrode current collector. A preferable positive electrode has the positive electrode layer on both faces of the positive electrode current collector from the viewpoint of further increasing the capacity of the battery (particularly secondary battery).

The positive electrode may be obtained, for example, by coating a positive electrode current collector with a positive electrode layer slurry prepared by mixing a positive electrode active material, a conductive material, and a binder in a dispersion medium, drying the slurry, and thereafter rolling the dried coating with a roll press machine or the like.

The linear pressure during rolling may be, for example, 0.1 t/cm or more and 1.0 t/cm or less, and from the viewpoint of further improving the cycle characteristics, the linear pressure during rolling is preferably 0.5 t/cm or more and 1.0 t/cm or less. The roll temperature is usually 100° C. or more and 200° C. or less, and from the viewpoint of further improving the cycle characteristics, the roll temperature is preferably 110° C. or more and 150° C. or less. The pressing speed is usually 1 m/min or more and 20 m/min or less, and from the viewpoint of further improving the cycle characteristics, the pressing speed is preferably 5 m/min or more and 15 m/min or less.

The negative electrode includes at least a negative electrode layer and a negative electrode current collector (foil), and the negative electrode layer may be provided on at least one face of the negative electrode current collector. For example, in the negative electrode, the negative electrode layer may be provided on both faces of the negative electrode current collector, or the negative electrode layer may be provided on one face of the negative electrode current collector. The negative electrode layer is preferably provided on both faces of the negative electrode current collector in the negative electrode from the viewpoint of further increasing the capacity of the secondary battery.

The negative electrode (particularly the negative electrode layer) contains at least a negative electrode active material, and may or may not contain a conductive material.

When the negative electrode contains a conductive material, the negative electrode may or may not have a conductive material covering structure. The negative electrode may or may not have an electrode active material covering structure.

When the negative electrode (particularly the negative electrode layer) has a conductive material covering structure, a conductive material covered with a covering material by the above-described method is used in the production of the negative electrode (particularly the negative electrode layer).

When the negative electrode (particularly the negative electrode layer) does not have a conductive material covering structure, the above-described conductive material that is not covered with a covering material is used as it is in the production of the negative electrode (particularly the negative electrode layer).

When the negative electrode (particularly the negative electrode layer) has an electrode active material covering structure, a negative electrode active material covered with a covering material by the above-described method is used in the production of the negative electrode (particularly the negative electrode layer).

When the negative electrode (particularly the negative electrode layer) does not have an electrode active material covering structure, the above-described negative electrode active material that is not covered with a covering material is used as it is in the production of the negative electrode (particularly the negative electrode layer).

The positive electrode active material contained in the positive electrode layer and the negative electrode active material contained in the negative electrode layer described above are substances directly involved in the transfer of electrons in the secondary battery, and are main substances of positive and negative electrodes responsible for charge and discharge, that is, the battery reaction. More specifically, ions are brought in the electrolyte due to the “positive electrode active material contained in the positive electrode layer” and the “negative electrode active material contained in the negative electrode layer”, and such ions move between the positive electrode and the negative electrode to transfer electrons, whereby charge and discharge are performed. In the present disclosure, the mediating ions are not particularly limited as long as charge and discharge can be performed, and examples thereof include lithium ions and sodium ions (particularly lithium ions). The positive electrode and the negative electrode are preferably electrodes capable of occluding and releasing lithium ions, that is, the positive electrode layer and the negative electrode layer are preferably layers capable of occluding and releasing lithium ions. That is, a secondary battery in which lithium ions move between the positive electrode and the negative electrode with the electrolyte interposed therebetween whereby charge and discharge of the battery is made is preferable. When lithium ions are involved in charging and discharging, the secondary battery according to this embodiment corresponds to a so-called “lithium ion battery”.

The content of the negative electrode active material in the negative electrode layer is usually 50 wt % or more and 98 wt % or less with respect to the total weight of the negative electrode layer, and is preferably 70 wt % or more and 98 wt % or less, and more preferably 85 wt % or more and 98 wt % or less from the viewpoint of further improving the cycle characteristics.

The content of the conductive material in the negative electrode layer is usually 0 wt % or more and 20 wt % or less with respect to the total weight of the negative electrode layer, and is preferably 0 wt % or more and 10 wt % or less, more preferably 0 wt % or more and 8 wt % or less, and still more preferably 0 wt % or more and 8 wt % or less from the viewpoint of further improving the cycle characteristics. The fact that the content of the conductive material in the negative electrode layer is 0 wt % means that the negative electrode layer does not contain a conductive material.

The negative electrode active material of the negative electrode layer is made of, for example, a particulate material, and preferably contains a binder for sufficient contact between particles and shape retention, and a conductive material may be contained in the negative electrode layer to facilitate transfer of electrons promoting the battery reaction. Because a plurality of components are contained as described above, the negative electrode layer may also be referred to as “negative electrode mixture layer” or the like.

The binder that may be contained in the negative electrode layer is not particularly limited, and examples thereof include at least one selected from the group consisting of styrene butadiene rubber, polyacrylic acid, polyvinylidene fluoride, a polyimide-based resin, and a polyamideimide-based resin. In a more preferred embodiment, the binder contained in the negative electrode layer is styrene butadiene rubber. The conductive assistant that may be contained in the negative electrode layer is not particularly limited, and examples thereof include at least one selected from carbon blacks such as thermal black, furnace black, channel black, Ketjen black, and acetylene black, carbon fibers such as graphite, carbon nanotube, and vapor-grown carbon fiber, metal powders such as copper, nickel, aluminum, and silver, polyphenylene derivatives, and the like. The negative electrode layer may contain a component derived from a thickener component (for example, carboxymethyl cellulose) used at the time of producing the battery.

In a more preferred embodiment, the negative electrode active material and the binder in the negative electrode layer are a combination of graphite and polyimide.

The thickness of the negative electrode layer is not particularly limited, and may be, for example, 1 μm or more and 300 μm or less, particularly 5 μm or more and 200 μm or less. The thickness of the negative electrode layer is the thickness inside the secondary battery, and an average value of measured values at any 50 points is used.

A negative electrode current collector used for the negative electrode is a member that contributes to collecting and supplying electrons generated in the active material due to the battery reaction. Similarly to the positive electrode current collector, the negative electrode current collector may be a sheet-like metal member or may have a porous or perforated form. For example, the negative electrode current collector may be a metal foil, a punching metal, a net, an expanded metal, or the like. The negative electrode current collector used for the negative electrode is preferably made of a metal foil containing at least one selected from the group consisting of copper, stainless steel, nickel, and the like, and may be, for example, a copper foil.

The negative electrode may be obtained, for example, by coating a negative electrode current collector with a negative electrode layer slurry prepared by mixing at least a negative electrode active material and a binder in a dispersion medium, drying the slurry, and thereafter rolling the dried coating with a roll press machine or the like.

In the production of the negative electrode, the linear pressure during rolling, the roll temperature, and the pressing speed are not particularly limited, and may be, for example, within the same ranges as the linear pressure during rolling, the roll temperature, and the pressing speed in the production of the positive electrode.

The separator is a member provided from the viewpoint of preventing a short circuit due to contact between the positive and negative electrodes, holding the electrolyte, and the like. In other words, it can be said that the separator is a member that allows ions to pass while preventing electronic contact between the positive electrode and the negative electrode. Preferably, the separator is a porous or microporous insulating member, and has a membrane form due to its small thickness. Although it is merely an example, a microporous membrane formed of polyolefin may be used as the separator. In this regard, the microporous membrane used as the separator may contain, for example, only polyethylene (PE) or only polypropylene (PP) as polyolefin. Furthermore, the separator may be a laminate formed of a “PE microporous membrane” and a “PP microporous membrane”. The surface of the separator may be covered with an inorganic particle coat layer and/or an adhesive layer or the like. The surface of the separator may have adhesiveness.

The thickness of the separator is not particularly limited, and may be, for example, 1 μm or more and 100 μm or less, particularly 5 μm or more and 20 μm or less. The thickness of the separator is the thickness inside the secondary battery (particularly, the thickness between the positive electrode and the negative electrode), and an average value of measured values at any 50 points is used.

The electrolyte assists movement of metal ions released from the electrodes (positive electrode and negative electrode). The electrolyte may be a “non-aqueous” electrolyte, such as an organic electrolyte and an organic solvent, or may be an “aqueous” electrolyte containing water. The secondary battery of the present disclosure is preferably a nonaqueous electrolyte secondary battery using an electrolyte containing a “nonaqueous” solvent and a solute as an electrolyte. The electrolyte may have a form such as liquid or gel (note that the term “liquid” nonaqueous electrolyte is also referred to herein as “nonaqueous electrolyte liquid”).

As a specific solvent for the nonaqueous electrolyte, a solvent containing at least a carbonate is preferred. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonate include at least one selected from the group consisting of dimethyl carbonate (DMC), diethyl carbonate (DEC), ethyl methyl carbonate (EMC), and dipropyl carbonate (DPC). In an embodiment of the present disclosure, a combination of a cyclic carbonate and a chain carbonate is used as the nonaqueous electrolyte, and for example, a mixture of ethylene carbonate and ethyl methyl carbonate is used.

As a specific solute of the nonaqueous electrolyte, for example, a Li salt such as LiPF₆ or LiBF₄ is preferably used.

The exterior body is not particularly limited, and may be, for example, a flexible pouch (soft bag body) or a hard case (hard casing).

When the exterior body is a flexible pouch, the flexible pouch is usually formed of a laminate film, and sealing is achieved by heat-sealing the peripheral edge portion. As the laminate film, a film obtained by laminating a metal foil and a polymer film is commonly used, and specifically, a film having a three-layer structure of outer layer polymer film/metal foil/inner layer polymer film is exemplified. The outer layer polymer film is for preventing damage of the metal foil due to permeation and contact of moisture and the like, and polymers such as polyamide and polyester may be suitably used. The metal foil is for preventing permeation of moisture and gas, and a foil of copper, aluminum, stainless steel, or the like may be suitably used. The inner layer polymer film is for protecting the metal foil from the electrolyte to be housed inside and for melt-sealing at the time of heat sealing, and polyolefin (for example, polypropylene) or acid-modified polyolefin may be suitably used. The thickness of the laminate film is not particularly limited, and may be, for example, 1 μm or more and 1 mm or less.

When the exterior body is a hard case, the hard case is usually formed of a metal plate, and sealing is achieved by irradiating the peripheral portion with laser. As the metal plate, a metal material made of aluminum, nickel, iron, copper, stainless steel, or the like is commonly used. The thickness of the metal plate is not particularly limited, and may be, for example, 1 μm or more and 1 mm or less.

### EXAMPLES

The present disclosure will be described below in further detail including with reference to Examples according to an embodiment.

### <Positive Electrode Active Material>

As a positive electrode active material, LiNi_{0.8}Co_{0.15}Al_{0.05}O₂ (NCA) was prepared.

### <Conductive Material>

As a conductive material, carbon black was prepared.

### (Covering Treatment on Conductive Material)

The conductive material was mixed with a covering solution in which a covering raw material was dissolved, and the mixture was stirred. Specifically, a first metal alkoxide and a second metal alkoxide were mixed in a solvent (NMP: N-methyl-2-pyrrolidone) so as to have a mass ratio shown in Table 14, and the mixture was stirred for 10 minutes until dissolved. The conductive material was added thereto, and the mixture was stirred at room temperature for 30 minutes. Subsequently, the solvent was removed by heating and drying at 100° C. for 10 hours to obtain a covered conductive material.

It is possible to obtain a desired covering amount in the conductive material by adjusting the amount of the covering raw material to be dissolved in the solvent.

### (Covering Treatment on Positive Electrode Active Material)

Covering treatment on the positive electrode active material was performed by the same method as the covering treatment method on the conductive material except that the positive electrode active material was used instead of the conductive material to obtain a covered positive electrode active material.

It is possible to obtain a desired covering amount in the positive electrode active material by adjusting the amount of the covering raw material to be dissolved in the solvent.

### (Production of Positive Electrode)

95 wt % of the positive electrode active material, 3 wt % of the conductive material, and 2 wt % of polyvinylidene fluoride (PVdF) were mixed to prepare a positive electrode mixture. The positive electrode mixture was dispersed or dissolved in N-methyl-2-pyrrolidone (M4P) to prepare a positive electrode layer slurry. This slurry was uniformly applied to a strip-shaped aluminum foil (positive electrode current collector) with a thickness of 15 μm to form coating. Next, the coating was dried with hot air, and then subjected to compression molding with a hydraulic cylinder or a roll press machine to form a positive electrode sheet having a positive electrode layer. The prepared positive electrode sheet was punched to a diameter of 16.5 mm, and vacuum-dried at 120° C. for 10 hours using a vacuum dryer to prepare a positive electrode sheet for preparing a coin cell.)

### (Production of Coin Cell)

Metal Li (thickness 0.24 mm, diameter 17 mm) was used as a negative electrode, and the punched metal Li was attached to a 200 μm-thick SUS plate and laminated in an anode cup. Thereafter, a separator (thickness 16 μm, diameter 17.5 mm) was punched out and laminated on the negative electrode. The separator was impregnated with 150 μL of an electrolyte, and the electrolyte was immersed in voids of the negative electrode and the separator.

The positive electrode sheet was laminated on the separator, and then an aluminum plate and a cathode cup were laminated. The resulting laminate was externally sealed with a caulking machine in a state where a gasket was disposed on its periphery, thereby preparing a coin cell (2016 type). As the electrolyte, a solution obtained by mixing so as to be 17.8 wt % of ethylene carbonate (EC), 48.7 wt % of dimethyl carbonate (DMC), 3.0 wt % of ethyl methyl carbonate (EMC), 11.5 wt % of fluoroethylene carbonate (FEC), 18.6 wt % of lithium hexafluorophosphate (LiPF6), and 0.4 wt % of lithium tetrafluoroborate (LiBF4) was used.

The coin cell was initially charged and discharged using a charge and discharge characteristic evaluation device. In the initial charging and discharging, the coin cell was charged at constant current and constant voltage up to an upper limit voltage of 4.25 V/a lower limit current of 0.005 C at a current of 0.1 C in a thermostatic chamber at 25° C., then rested for 10 minutes, and discharged to a lower limit voltage of 2.0 V at a current of 0.1 C.)

### (Cycle Test)

A charge-discharge cycle test was performed in a thermostatic chamber at 60° C. under the following conditions. The coin cell was rested for 3 hours, and then charged at constant current and constant voltage up to an upper limit voltage of 4.25 V/a lower limit current of 0.01 C at a current of 1.0 C. After charging, the coin cell was rested for 1 minute, discharged to a lower limit voltage of 2.5 V at a current of 5.0 C, and then rested for 5 minutes. This charging and discharging test was performed 100 cycles.

The capacity ratio represented by the following formula was listed as a cycle maintenance rate in Table 14.

(Cycle retention rate)=(discharge capacity after 100 cycles)/(discharge capacity at first cycle)×100

The cycle retention rate was evaluated based on the following indices.
⊙: 90% or more (best);
◯: 80% or more and less than 90% (excellent);
Δ: 75% or more and less than 80% (no problem in practical use);
X: less than 75% (problem in practical use)

In addition, EIS measurement was performed after 100 cycles. The EIS measurement was performed under the following conditions. The coin cell was charged at constant current and constant voltage up to an upper limit voltage of 4.25 V/a lower limit current of 0.005 C at a charge current of 0.2 C in a thermostatic chamber at 25° C. to prepare a state of charge (hereinafter, SOC) of 100%. The EIS measurements were performed at a voltage amplitude of 10 mV with the frequency varied from 1 MHz to 0.1 Hz. From the measurement results, positive electrode resistance was calculated using a semicircle extrapolated to a component of 100 Hz to 10 Hz as the positive electrode resistance.

The resistance ratio represented by the following formula was listed as a cycle resistance deterioration rate in Table 14.

(Cycle resistance deterioration rate)=(positive electrode resistance after 100 cycles)/(positive electrode resistance at first cycle)×100

The cycle resistance deterioration rate was evaluated based on the following indices.
⊙: less than 500% (best);
◯: 500% or more and less than 550% (excellent);
Δ: 550% or more and less than 600% (no problem in practical use);
X: 600% or more (problem in practical use)

### Examples 2 to 10 and Comparative Examples 1 to 2

In the covering treatment on the conductive material and the positive electrode active material, coin cells were produced in the same manner as in Example 1 except that the type of the covering raw material and the covering amount of the covering material were adjusted as shown in Table 14, and cycle tests were performed.

In Examples 3 and 4 and Comparative Examples 1 and 2, specifically, the positive electrode active material was used as it was without being covered.

In Example 10, specifically, material Y was used instead of material X in the covering treatment on the conductive material and the positive electrode active material.

The positive electrode produced in each of Examples 1 to 10 was disassembled and observed with a microscope, and it was confirmed that at least a part of the conductive material was covered with the covering material.

The positive electrode produced in each of Examples 1 to 2 and 5 to 10 was disassembled and observed with a microscope, and it was confirmed that at least a part of the positive electrode active material was covered with the covering material.

### <Method for Calculating Covering Amount of Covering Material on Conductive Material>

The covering amount of the covering material on the conductive material is calculated by the following formula.

Covering amount of covering material on conductive material [mmol/m²]=A/B

In the above formula, A is calculated by the following formula.

A[mmol]=1000×(covering material content in electrode [g]−covering material content in electrode active material [g])/molecular weight of covering material

B is a surface area [m²] of the conductive material contained in the electrode.

### <Method for Calculating Covering Amount of Covering Material on Electrode Active Material>

The covering amount of the covering material on the electrode active material is calculated by the following formula.

Covering amount of covering material on electrode active material [mmol/m²]=C/D

In the above formula, C is calculated by the following formula.

C[mmol]=1000×(covering material content in electrode active material [g])/molecular weight of covering material

D is a surface area [m²] of the electrode active material contained in the electrode.

### <Method for Measuring Covering Material Content in Electrode>

The covering material content contained in the electrode was calculated by subjecting the electrode to an inductively coupled plasma atomic emission spectrometer.

### <Method for Measuring Covering Material Content in Electrode Active Material>

The electrode was immersed in n-methylpyrrolidone or the like capable of swelling and dissolving the electrode, only the electrode active material was extracted from the electrode, and emission spectroscopic analysis of the electrode active material was performed by the same method as the method for measuring the covering material content in the electrode, thereby calculating the covering material content in the electrode active material.

TABLE 14

| | | | | Covering | | | |
|---|---|---|---|---|---|---|---|
| | | | | material | | | |
| | | | | amount | | | |
| | | | Electrode | ratio | Battery | | |
| | | Conductive | active | conductive | characteristics | | |
| | | material | material | material/ | | Cycle | |
| | Covering | covering | covering | electrode | Cycle | resistance | |
| | raw material | amount | amount | active | retention | deterioration | Comprehensive |
| | (Mass ratio) | [mmol/m2] | [mmol/m2] | material | rate | rate | evaluation |
| Example 1 | TEOS/BTESE | 0.02 | 0.002 | 91/9 | Δ | ◯ | Δ |
| | (40/60) | | | | 79 | 510 | |
| Example 2 | TEOS/BTESE | 0.03 | 0.24 | 11/89 | Δ | Δ | Δ |
| | (40/60) | | | | 78 | 560 | |
| Example 3 | TEOS/BTESE | 0.040 | * | — | ◯ | ◯ | ◯ |
| | (40/60) | | | | 87 | 510 | |
| Example 4 | TEOS/BTESE | 0.002 | * | — | ◯ | ◯ | ◯ |
| | (40/60) | | | | 86 | 515 | |
| Example 5 | TEOS/BTESE | 0.02 | 0.02 | 50/50 | ◯ | ⊙ | ⊙ |
| | (5/95) | | | | 87 | 460 | |
| Example 6 | TEOS/BTESE | 0.03 | 0.015 | 67/33 | ◯ | ⊙ | ⊙ |
| | (50/50) | | | | 86 | 450 | |
| Example 7 | TEOS/BTESE | 0.01 | 0.04 | 20/80 | ⊙ | ⊙ | ⊙⊙ |
| | (50/50) | | | | 91 | 430 | |
| Example 8 | TEOS/BTESE | 0.001 | 0.20 | 0.5/99.5 | ⊙ | ⊙ | ⊙⊙ |
| | (50/50) | | | | 90 | 460 | |
| Example 9 | TEOS/BTESE | 0.01 | 0.003 | 77/23 | ⊙ | ◯ | ⊙ |
| | (5/95) | | | | 90 | 520 | |
| Example 10 | LBO | 0.04 | 0.04 | 5/5 | ⊙ | ◯ | ⊙ |
| | (Lithium borate) | | | | 91 | 530 | |
| Comparative | TEOS/BTESE | 0.005 | * | — | X | X | X |
| Example 1 | (30/70) | | | | 74 | 610 | |
| Comparative | TEOS/BTESE | 0.080 | * | — | X | X | X |
| Example 2 | (50/50) | | | | 74 | 620 | |

*Covering treatment was not performed.

The secondary battery according to the present disclosure can be used in various fields in which battery use or electricity storage is assumed. By way of example only, the secondary battery according to the present disclosure, particularly the nonaqueous electrolyte secondary battery, can be used in the field of electronics mounting. The secondary battery according to an embodiment of the present disclosure can also be used in the fields of electricity, information, and communication in which mobile devices and the like are used (for example, electric and electronic equipment fields or mobile equipment fields including mobile phones, smartphones, smartwatches, notebook computers, and small electronic machines such as digital cameras, activity meters, arm computers, electronic papers, wearable devices, RFID tags, card-type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as hearing aid buds), pharmaceutical applications (fields such as dosage management systems), IoT fields, space and deep sea applications (for example, fields such as space probes and submersibles), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode including an electrode active material and a conductive material, wherein
at least a part of the conductive material is covered with a covering material, and
a covering amount of the covering material is 0.0008 mmol/m² or more and 0.06 mmol/m² or less.

2. The secondary battery according to claim 1, wherein the covering material includes a material X, a material, or a mixture thereof,
wherein the material X includes a reactant material including at least a first metal alkoxide including no metal atom-carbon atom bond in one molecule and a second metal alkoxide including one or more metal atom-carbon atom bonds in one molecule, and
wherein the material Y includes a lithium-containing composite oxide including lithium and one or more elements selected from a group consisting of a Group 2 element, a transition metal element, a rare earth element, a Group 13 element, a Group 14 element, and a Group 15 element.

3. The secondary battery according to claim 2, wherein the first metal alkoxide is a compound represented by general formula (1) shown below:
M¹(OR¹)ₓ (1)
wherein M¹ is Si, Ti, Al, or Zr;
x is a valence of M¹ and is an integer of 3 or 4;
R¹s each independently are an alkyl group having 1 to 10 carbon atoms or —C(R²)═CH—CO—R³, where R² is an alkyl group having 1 to 10 carbon atoms and R³ is an alkyl group having 1 to 30 carbon atoms, an alkyloxy group having 1 to 30 carbon atoms, or an alkenyloxy group having 1 to 30 carbon atoms; and
two adjacent R¹s among the R¹s may be bonded to each other to form one ring together with an oxygen atom to which the two R¹s are bound and an M¹ atom to which the oxygen atom is bound when the two R¹s are the alkyl groups.

4. The secondary battery according to claim 2, wherein the second metal alkoxide is a compound having two or more Si atom-carbon atom bonds in one molecule.

5. The secondary battery according to claim 2, wherein the second metal alkoxide is a compound represented by general formula (2A), (2B), (2C), (2D), (2E), (2F) shown below, or a mixture thereof:
(R²¹O)₃Si—R³¹—Si(OR²¹²)₃ (2A)
wherein R²¹¹s and R²¹²s each independently are an alkyl group having 1 to 10 carbon atoms; and
R³¹ is a divalent hydrocarbon group having 1 to 20 carbon atoms, 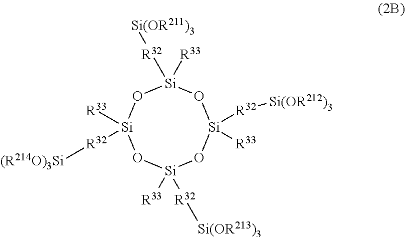
wherein R²¹¹s, R²¹²s, R²¹³s, and R²¹⁴s each independently are an alkyl group having 1 to 10 carbon atoms;
R³²s each independently are a divalent hydrocarbon group having 1 to 20 carbon atoms; and
R³³s each independently are a monovalent hydrocarbon group having 1 to 10 carbon atoms,
(R²¹¹O)ₐSi—R³⁴—NH—R³⁵—NH—R³⁶—Si(OR²¹²)₃ (2C)
wherein R²¹¹s and R²¹²s each independently are an alkyl group having 1 to 10 carbon atoms; and
R³⁴, R³⁵, and R³⁶ each independently are a divalent hydrocarbon group having 1 to 10 carbon atoms,
(R²¹¹)₂—Si(OR²¹²)₂ (2D)
wherein R²¹¹s and R²¹²s each independently are an alkyl group having 1 to 10 carbon atoms, 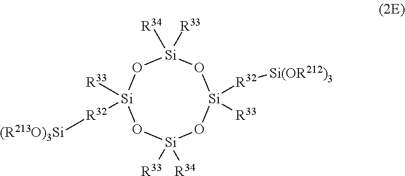
wherein R²¹²s and R²¹³s each independently are an alkyl group having 1 to 10 carbon atoms;
R³²s each independently are a divalent hydrocarbon group having 1 to 20 carbon atoms;
R³³s each independently are a monovalent hydrocarbon group having 1 to 10 carbon atoms; and
R³⁴s each independently are a monovalent hydrocarbon group having 8 to 30 carbon atoms, 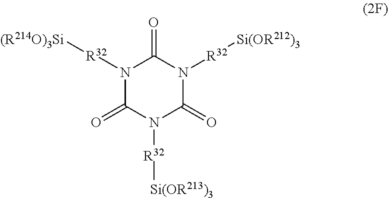
wherein R²¹²s, R²¹³s and R²¹⁴s each independently are an alkyl group having 1 to 10 carbon atoms; and
R³²s each independently are a divalent hydrocarbon group having 1 to 20 carbon atoms.

6. The secondary battery according to claim 2, wherein the material X includes 1 wt % or more and 99 wt % or less of the first metal alkoxide and 1 wt % or more and 99 wt % or less of the second metal alkoxide with respect to a total weight of the material X.

7. The secondary battery according to claim 2, wherein the material Y is a compound represented by general formula (4):
LiₐM_{b}O_{c} (4)
wherein M is one or more elements selected from a group consisting of a Group 2 element, a transition metal element, a rare earth element, a Group 13 element, a Group 14 element, and a Group 15 element;
a is an integer of 1 or more and 4 or less;
b is an integer of 1 or more and 5 or less; and
c is an integer of 2 or more and 8 or less.

8. The secondary battery according to claim 7, wherein M includes one or more elements selected from a group consisting of tungsten (W), boron (B), silicon (Si), and phosphorus (P).

9. The secondary battery according to claim 1, wherein
the conductive material is at least one selected from a group consisting of a carbon black and a carbon fiber,
the carbon black is one or more selected from a group consisting of a thermal black, a furnace black, a channel black, a ketjen black, and an acetylene black, and
the carbon fiber is one or more selected from a group consisting of a graphite, a carbon nanotube, and a vapor grown carbon fiber.

10. The secondary battery according to claim 1, wherein
the conductive material is formed of one or both of primary particles and secondary particles in which a plurality of primary particles are aggregated, and
the covering material of the conductive material is present on at least a part of surfaces of the primary particles and/or at least a part of voids between the primary particles in the conductive material.

11. The secondary battery according to claim 1, wherein
at least a part of the electrode active material is covered with the covering material, and
a covering amount of the covering material in the electrode active material is 0.001 mmol/m² or more and 0.40 mmol/m² or less.

12. The secondary battery according to claim 11, wherein the covering material of the electrode active material is substantially a same material as the covering material of the conductive material.

13. The secondary battery according to claim 1, wherein
at least a part of the electrode active material is covered or is not covered with the covering material, and
when at least a part of the electrode active material is covered with the covering material, a covering amount of the covering material in the electrode active material is 0.0025 mmol/m² or more and 0.22 mmol/m² or less.

14. The secondary battery according to claim 11, wherein a covering amount of the covering material in the electrode active material is 0.0025 mmol/m² or more and 0.22 mmol/m² or less.

15. The secondary battery according to claim 11, wherein
a covering amount of the covering material in the electrode active material is 0.0025 mmol/m² or more and 0.22 mmol/m² or less, and
covering amount M of the covering material in the conductive material and covering amount N of the covering material in the electrode active material satisfy relational expression shown below:
M/N=0.1/99.9 or more and 40/60 or less.

16. The secondary battery according to claim 11, wherein
the electrode active material is formed of one or both of particles and secondary particles in which a plurality of primary particles are aggregated, and
when at least a part of the electrode active material is covered with the covering material, the covering material of the electrode active material is present in at least a part of a surface of the primary particles and/or at least a part of voids between the primary particles in the electrode active material.

17. The secondary battery according to claim 1, wherein the electrode is a positive electrode.

18. The secondary battery according to claim 1, wherein the secondary battery is a lithium ion secondary battery.

19. The secondary battery according to claim 1, wherein the electrode, a separator, and an electrolyte are enclosed in an exterior body.

20. The secondary battery according to claim 19, wherein the electrolyte is a nonaqueous electrolyte.

21. The secondary battery according to claim 1, wherein the electrode is an electrode capable of occluding and releasing lithium ions.

22. A method for covering a conductive material, comprising: stirring a conductive material together with a solution including a raw material of the covering material of a materials X, a material Y, or a mixture thereof, and then removing a solvent;
wherein the material X includes a reactant material including at least a first metal alkoxide containing no metal atom-carbon atom bond in one molecule and a second metal alkoxide including one or more metal atom-carbon atom bonds in one molecule, and
wherein the material Y includes a lithium-containing composite oxide containing Li (lithium) and one or more elements selected from a group consisting of a Group 2 element, a transition metal element, a rare earth element, a Group 13 element, a Group 14 element, and a Group 15 element.
